(19) United States
(12) Patent Application Publication
(10) Pub. No.: US 2022/0172276 A1
(43) Pub. Date: Jun. 2, 2022

(54) SYSTEM FOR SHOPPING MALL SERVICE USING EYE TRACKING TECHNOLOGY AND COMPUTING DEVICE FOR EXECUTING SAME

(71) Applicant: VisualCamp Co., Ltd., Seoul (KR)

(72) Inventors: Yun Chan SUK, Seoul (KR); Seung Woo LEE, Seoul (KR); Tae Hee LEE, Seoul (KR)

(21) Appl. No.: 17/548,893

(22) Filed: Dec. 13, 2021

Related U.S. Application Data
(63) Continuation of application No. PCT/KR2020/007551, filed on Jun. 11, 2020.

(30) Foreign Application Priority Data
Jun. 13, 2019 (KR) 10-2019-0070203

(51) Int. Cl. G06Q 30/06; G06F 3/01; G06V 40/16

(52) U.S. Cl. CPC G06Q 30/0641; G06Q 30/0631; G06V 40/174; G06F 3/013

(57) ABSTRACT

A computing device according to an embodiment of the present disclosure includes one or more processors, a memory storing one or more programs executed by the one or more processors, a communication module that receives eye tracking information about a user on a shopping mall page from a user terminal, and a product arrangement module that rearranges a product displayed on the shopping mall page based on the eye tracking information.

### CROSS REFERENCE TO RELATED APPLICATIONS AND CLAIM OF PRIORITY

The present application is a continuation application to International Application No. PCT/KR2020/007551 with an International Filing Date of Jun. 11, 2020, which claims the benefit of Korean Patent Application No. 10-2019-0070203 filed on Jun. 13, 2019 at the Korean Intellectual Property Office, the disclosures of which are incorporated by reference herein in their entirety.

### BACKGROUND

### 1. Technical Field

The following description relates to a technology for a shopping mall service using an eye tracking technology.

### 2. Description of the Related Art

Eye tracking is a technology for tracking the position of the gaze by detecting eye movement of a user, and may be performed by methods such as an image analysis method, a contact lens method, and a sensor attachment method. The image analysis method detects the movement of the pupil through analysis of real-time camera images, and calculates the direction of the gaze based on the fixed position reflected by the cornea. The contact lens method uses the reflected light of the mirror-built contact lens or the magnetic field of the coil-built contact lens, which lead to low convenience, but high accuracy. The sensor attachment method detects eye movement using a change in an electric field with eye movement by a sensor attached around the eye; with the method, the eye movement may be detected even when the eyes are closed (sleep or the like).

In recent years, devices and fields to which the eye tracking technology is applied have been gradually expanding, and as a result, attempts to use the eye tracking technology have been increasingly made in tracking people's eyes to collect data such as preferred products or services.

### SUMMARY

The disclosed embodiments of the present disclosure are intended to provide a new technique related to a technology for a shopping mall service using an eye tracking technology.

In one general aspect, there is provided a computing device including one or more processors, and a memory storing one or more programs executed by the one or more processors. The computing device includes a communication module configured to receive eye tracking information about a user on a shopping mall page from a user terminal, and a product arrangement module configured to rearrange a product displayed on the shopping mall page based on the eye tracking information.

The product arrangement module may calculate an interest level of each of the products displayed on the shopping mall page based on the eye tracking information, and rearrange each of the products on the shopping mall page according to the calculated interest level.

The product arrangement module may check a total stay time of gazes of users and a total number of times of the gazes of the users for each of the products on the shopping mall page based on the eye tracking information, and calculate the interest level for each of the products based on the total stay time of the gazes of users and the total number of times of the gazes of the users.

The product arrangement module may delete, from a landing page of the shopping mall pages, a product with the interest level equal to or lower than a preset threshold during a predetermined period of time among products displayed on the landing page.

The product arrangement module may calculate a gaze level of users for each of areas of the shopping mall page based on the eye tracking information, and rearrange each product on the shopping mall page based on the gaze level of users and a yield of each product for each of the areas of the shopping mall page.

The product arrangement module may arrange products having higher yields in areas where the gaze levels of users are higher on the shopping mall page.

The product arrangement module may predict a next gaze position of the user on the shopping mall page based on the eye tracking information, and arrange a preset product at the predicted next gaze position.

The computing device may further include an event management module configured to extract a product of interest of the user from among the products displayed on the shopping mall page based on the eye tracking information, and provide event information on the product of interest to the user terminal when an event is conducted for the product of interest.

The computing device may further include an information providing module configured to provide information in another form about a product displayed on the shopping mall page based on the eye tracking information.

The information providing module may change an image of a product in which the gaze of the user stays for a preset reference time or longer or a product at which the user gazes a preset reference number of times or more on the shopping mall page from 2D to 3D and display the changed image.

The information providing module may extract a product of interest of the user from among the products displayed on the shopping mall page, and provide a related product corresponding to the product of interest in a form of a thumbnail image or a pop-up window.

The information providing module may check a residence time of the user on a product detail page of the shopping mall pages, and calculate a concentration level of the user on the product detail page based on the eye tracking information and the residence time on the product detail page.

The information providing module may provide, to the user terminal, additional purchase information about a product corresponding to the product detail page, when the concentration level of the user on the product detail page is equal to or greater than a preset reference, but the user does not purchase the product.

The information providing module may calculate a page residence time for each shopping mall page with respect to the user, calculate the concentration level of the user for each shopping mall page based on the page residence time and the eye tracking information, and set a preset number of shopping mall pages having the highest concentration level of the user among the shopping mall pages as bookmarks.

The computing device may further include an interest price range calculation module configured to calculate an interest price range of the user based on a price of a product in which a gaze of the user stays on the shopping mall page and a time when the gaze of the user stays.

The interest price range calculation module may calculate the interest price range of the user based on a price of a product for which the time when the gaze of the user stays is less than a preset first time and a price of a product for which the time when the gaze of the user stays is equal to or longer than a second time set to be longer than the first time, on the shopping mall page.

The communication module may receive, from the user terminal, a face photographed image of the user viewing the shopping mall page, and the computing device may further include an emotion analysis module configured to analyze emotion of the user on the shopping mall page based on the face photographed image.

In another general aspect, there is provided a computing device including one or more processors, a memory storing one or more programs executed by the one or more processors. The computing device includes a communication module configured to receive eye tracking information about a user on a shopping mall page from a user terminal, and an information providing module configured to provide information in another form about a product displayed on the shopping mall page based on the eye tracking information.

In still another general aspect, there is provided a computing device including one or more processors, and a memory storing one or more programs executed by the one or more processors. The computing device includes a communication module configured to receive eye tracking information about a user on a shopping mall page from a user terminal, and an interest price range calculation module configured to calculate an interest price range of the user based on a price of a product in which a gaze of the user stays on the shopping mall page and a time when the gaze of the user stays.

In yet still another general aspect, there is provided a system for a shopping mall service using eye tracking according to an embodiment including: a user terminal configured to generate eye tracking information about a user on a shopping mall page; and a shopping mall management server configured to receive the eye tracking information from the user terminal, and rearranges a product displayed on the shopping mall page based on the eye tracking information.

According to the disclosed embodiments, by rearranging the products on the shopping mall page based on eye tracking information about the user, products with a high interest level of the user are arranged in the front part, which makes it possible to improve product sales.

In addition, by extracting a product of interest of the user from among the products displayed on the shopping mall page based on the eye tracking information about the user, it is possible to carry out customized marketing for users who take the product as the product of interest when an event occurs for the product.

In addition, by providing different type of information or additional information about a product of interest of the user, it is possible for the user to sufficiently understand and buy the product.

### BRIEF DESCRIPTION OF THE DRAWINGS

FIG. 1 is a diagram for illustrating a configuration of a system for a shopping mall service using eye tracking according to an embodiment of the present disclosure.

FIG. 2 is a block diagram for illustrating a configuration of a shopping mall management server according to an embodiment of the present disclosure.

FIG. 3 is a block diagram for exemplarily illustrating a computing environment that includes a computing device suitable for use in exemplary embodiments.

### DETAILED DESCRIPTION

Hereinafter, specific embodiments of the present disclosure will be described with reference to the accompanying drawings. The following detailed description is provided to assist in a comprehensive understanding of the methods, devices and/or systems described herein. However, the detailed description is only for illustrative purposes and the present disclosure is not limited thereto.

In describing the embodiments of the present disclosure, when it is determined that detailed descriptions of known technology related to the present disclosure may unnecessarily obscure the gist of the present disclosure, the detailed descriptions thereof will be omitted. The terms used below are defined in consideration of functions in the present disclosure, but may be changed depending on the customary practice or the intention of a user or operator. Thus, the definitions should be determined based on the overall content of the present specification. The terms used herein are only for describing the embodiments of the present disclosure, and should not be construed as limitative. Unless expressly used otherwise, a singular form includes a plural form. In the present description, the terms “including”, “comprising”, “having”, and the like are used to indicate certain characteristics, numbers, steps, operations, elements, and a portion or combination thereof, but should not be interpreted to preclude one or more other characteristics, numbers, steps, operations, elements, and a portion or combination thereof.

In the following description, the terminology “transmission”, “communication”, “reception” of a signal or information and terminology similar thereto may include a meaning in which the signal or information is directly transmitted from one element to another element and transmitted from one element to another element through an intervening element. In particular, “transmission” or “sending” of the signal or information to one element may indicate a final destination of the signal or information and may not imply a direct destination. The same is true for “reception” of the signal or information. In addition, in the present specification, a meaning in which two or more pieces of data or information are “related” indicates that when any one piece of data (or information) is obtained, at least a portion of other data (or information) may be obtained based thereon.

Further, it will be understood that, although the terms first, second, etc. may be used herein to describe various elements, these elements should not be limited by these terms. These terms may be used to distinguish one element from another element. For example, without departing from the scope of the present disclosure, a first element could be termed a second element, and similarly, a second element could be termed a first element.

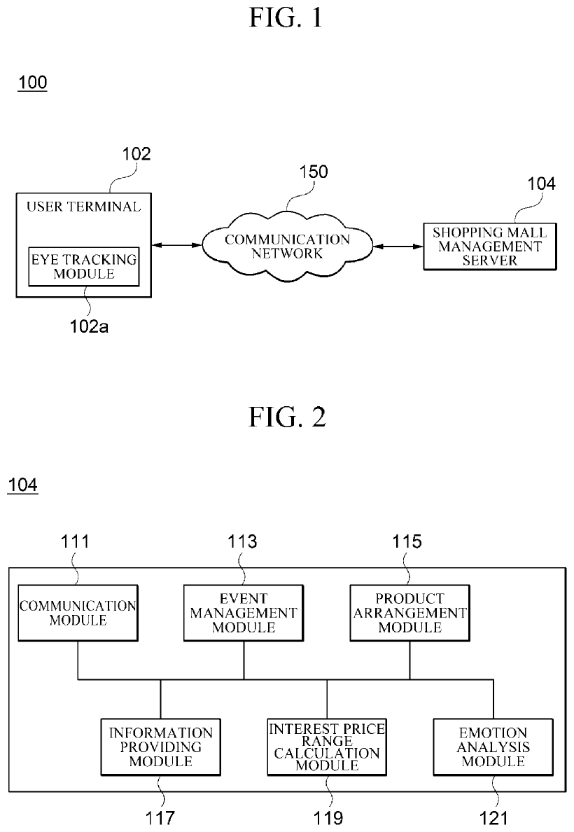

FIG. 1 is a diagram for illustrating a configuration of a system for a shopping mall service using eye tracking according to an embodiment of the present disclosure.

Referring to FIG. 1, a system for a shopping mall service (shopping mall service system) 100 using eye tracking may include a user terminal 102 and a shopping mall management server 104. The user terminal 102 is communicatively connected to the shopping mall management server 104 via a communication network 150. In some embodiments, the communication network 150 may include the Internet, one or more local area networks, wide area networks, cellular networks, mobile networks, other types of networks, or a combination of the above networks.

The user terminal 102 may be a terminal of a user who uses (or wants to use) an online shopping mall. In an exemplary embodiment, the user terminal 102 may include a smartphone, a tablet pc, a laptop computer, a desktop computer, and the like. The user terminal 102 may access the shopping mall management server 104 to receive a shopping mall page. The user terminal 102 may include an eye tracking module 102a.

Here, the user terminal 102 may receive a shopping mall page through a web browser or may receive a shopping mall page through a shopping mall application (shopping mall app) installed in the user terminal 102.

The eye tracking module 102a is mounted on the user terminal 102, and may track the gaze of the user on a screen of the user terminal 102. In an exemplary embodiment, when a shopping mall page is displayed on the screen of the user terminal 102, the eye tracking module 102a may generate eye tracking information by tracking the gaze of the user on the shopping mall page. The eye tracking information may contain a gaze position of the user on the shopping mall page, a time when the gaze of the user stays, and information on movement of the gaze of the user. The eye tracking technology for the user is a known technology, and thus a detailed description thereof will not be repeated.

Here, the eye tracking information is generated by tracking the gaze of the user on the shopping mall page displayed on the screen of the user terminal 102, and the shopping mall page displayed on the screen of the user terminal 102 is not limited to what is provided in any form or method. That is, the shopping mall page displayed on the screen of the user terminal 102 may be provided through a web browser, may be provided through a shopping mall app, or may be provided in various other methods (for example, a mixed form of a web browser and a shopping mall app).

The user terminal 102 may transmit eye tracking information and user identification information to the shopping mall management server 104. Here, the user identification information may include a user ID or identification information about the user terminal 102. Further, the user terminal 102 may transmit an image (a face photographed image) obtained by photographing the face of the user viewing a shopping mall page to the shopping mall management server 104.

The shopping mall management server 104 may be a management server for online shopping mall operation. The shopping mall management server 104 may provide the shopping mall page to the user terminal 102 according to the access of the user terminal 102. FIG. 2 is a block diagram for illustrating a configuration of the shopping mall management server according to an embodiment of the present disclosure.

Referring to FIG. 2, the shopping mall management server 104 may include a communication module 111, an event management module 113, a product arrangement module 115, an information providing module 117, an interest price range calculation module 119, and an emotion analysis module 121.

In an exemplary embodiment, the communication module 111, the event management module 113, the product arrangement module 115, the information providing module 117, the interest price range calculation module 119, and the emotion analysis module 121 may be constructed by using one or more physically separated devices, or may be implemented by one or more processors or a combination of one or more processors and software, and may not be clearly distinguished in specific operations, unlike the illustrated example.

The communication module 111 may communicate with the user terminal 102. The communication module 111 may receive, from the user terminal 102, the eye tracking information and user identification information for the user. The communication module 111 may receive a face photographed image from the user terminal 102.

The event management module 113 may extract a product of interest of the user based on the eye tracking information for the user. That is, the event management module 113 may extract a product in which the user is interested from among the products displayed on the shopping mall page, based on the eye tracking information for the user on the shopping mall page. For example, the event management module 113 may extract, from among the products displayed on the shopping mall page, a product in which the gaze of the user stays for a preset reference time or longer or a product at which the user gazes a preset reference number of times or more, as a product of interest of the user.

The event management module 113 may match and store the product of interest with the corresponding user. For example, the event management module 113 may match and store the product of interest with user identification information about the corresponding user. The user identification information may be stored in the shopping mall management server 104 by matching with contact information about the corresponding user (e.g., e-mail, social network service (SNS), or the like).

The event management module 113 may extract users who have a predetermined product as a product of interest when an event is conducted for the product. The event management module 113 may provide event information on the product to the user terminals 102 of the extracted users. Here, the event information may include a discount coupon for the product. In an exemplary embodiment, the event management module 113 may transmit event information on the product to the user terminal 102 through a push notification. In addition, the event management module 113 may transmit event information on the product to the user's email, SNS, or the like as a notification.

The product arrangement module 115 may calculate an interest level (or concentration level of gaze) of each product displayed on the shopping mall page based on the eye tracking information about the user. In an exemplary embodiment, the product arrangement module 115 may calculate the interest level of each product on the shopping mall page based on the eye tracking information about the user for a preset period of time, and may rearrange each product on the shopping mall page according to the calculated interest level.

The product arrangement module 115 may check a total stay time of gazes of users and a total number of times of the gazes of the users for each product on the shopping mall page and calculate the interest level for each product based on the checked time and number of times. The product arrangement module 115 may rearrange products in an order of increasing interest level of the product on the shopping mall page.

The product arrangement module 115 may expose a preset number of products having the highest interest levels among products on a landing page (main page) or an event page of the online shopping mall. For example, the product arrangement module 115 may sequentially expose a preset number of products with the highest interest levels on a landing page or an event page of the online shopping mall. Here, the event management module 113 may perform an event such as a discount coupon for the product exposed on the landing page or the event page.

In an exemplary embodiment, the product arrangement module 115 may delete, from the landing page of the online shopping mall, a product with the interest level equal to or lower than a preset threshold during a preset period of time, among products displayed on the landing page.

In addition, the product arrangement module 115 may calculate a gaze level of users for each area of the shopping mall page (e.g., the landing page) based on the eye tracking information about the user. Here, the gaze level of the users may be calculated based on the times when the gazes of the users stay, the number of times of the gazes of the users, or the like. Further, the product arrangement module 115 may store the yield of each product sold on the online shopping mall.

The product arrangement module 115 may arrange products based on the gaze level of the users for each area of the shopping mall page and the yield of each product. In an exemplary embodiment, the product arrangement module 115 may arrange products having higher yields in areas where the gaze levels of users are higher on the shopping mall page. For example, the product arrangement module 115 may arrange the product with the highest yield on the shopping mall page in an area where the gaze level of the users is highest, and arrange the product with the second highest yield in an area where the gaze level of the users is the second highest.

In addition, the product arrangement module 115 may predict a next gaze position of the user based on the eye tracking information about the user. The product arrangement module 115 may analyze a gaze trajectory of the user based on gaze movement information about the user in the eye tracking information about the user, and may predict the next gaze position of the user according to the gaze trajectory of the user. The prediction of the next gaze position of the user may be performed by a machine learning technique.

That is, the product arrangement module 115 may include a machine learning model for predicting the next gaze position of the user. The machine learning model may be a machine learned model to output the next gaze position of the user when the gaze movement information about the user is input.

The product arrangement module 115 may arrange a preset product at the predicted next gaze position of the user on the shopping mall page. For example, the product arrangement module 115 may arrange a product having a yield equal to or greater than preset reference at the predicted next gaze position of the user on the shopping mall page. Further, the product arrangement module 115 may arrange a product having the highest yield among products of interest of the user at the predicted next gaze position of the user on the shopping mall page.

The information providing module 117 may provide other types of information about the product based on the eye tracking information about the user. In an exemplary embodiment, the information providing module 117 may transform and display a product of a 2D image to a 3D image on a shopping mall page based on the eye tracking information about the user. For example, the information providing module 117 may change an image of a product in which the gaze of the user stays for a preset reference time or longer or a product at which the user gazes a preset reference number of times or more on the shopping mall page from 2D to 3D, and display the changed image.

The information providing module 117 may match and store the 2D image of each product sold in the online shopping mall with its 3D image. Here, the 3D product image may be provided so that the direction is changed with input of the user. In this case, the user may view the 3D product image from various directions, and thus it is possible to sufficiently obtain visual information about the product.

Furthermore, the information providing module 117 may provide a related product corresponding to the product of interest of the user in the form of a thumbnail image or a pop-up window on the shopping mall page. The information providing module 117 may extract, from among the products displayed on the shopping mall page, a product in which the gaze of the user stays for a preset reference time or longer or a product at which the user gazes a preset reference number of times or more, as a product of interest of the user.

For example, when the product of interest of the user on the shopping mall page is a female top blouse, the information providing module 117 may provide a female bottom (e.g., skirt or pants) matching the product of interest (female top blouse) in the form of a thumbnail image or a pop-up window.

In addition, when the product of interest of the user on the shopping mall page is a solid-state drive (SSD) with a capacity of one terabyte (1 TB), the information providing module 117 may provide a hard disk drive (HDD) with a capacity of two terabytes with a price similar to that of the product of interest (1 TB SSD) in the form of a thumbnail image or a pop-up window.

Further, the information providing module 117 may check a stay time on the product detail page of the shopping mall pages (i.e., the residence time on the product detail page) for each user. The information providing module 117 may check the concentration level of the user on the product detail page based on the eye tracking information about the user and the residence time on the product detail page. That is, the information providing module 117 may check the concentration level of the user on the product detail page through the time when the gaze position of the user stays on the product detail page compared to the residence time on the product detail page.

When the concentration level of the user on the product detail page is equal to or greater than a preset reference, but the user does not purchase the product, the information providing module 117 may provide, to the user terminal 102 of the user, additional purchase information for the product (e.g., a discount coupon for the product, information on a review of the product (review video link, or the like), or the like).

That is, when the user has a high concentration level on the product detail page, but does not purchase the product, in many cases, the user may intend to purchase the product, but want more information on the product, and thus additional purchase information for the product may be provided to induce purchase of the product.

In addition, the information providing module 117 may calculate the concentration level of the user for each shopping mall page. That is, the information providing module 117 may calculate the page residence time for each shopping mall page for the user, and calculate the concentration level of the user through the time when the gaze position of the user stays on the corresponding page compared to the page residence time. The information providing module 117 may automatically set a preset number of shopping mall pages having the highest concentration level of the user among the shopping mall pages as bookmarks.

The interest price range calculation module 119 may calculate an interest price range of the user based on eye tracking information about the user. The interest price range calculation module 119 may calculate the interest price range of the user based on a price of a product in which a gaze of the user stays and a time when the gaze of the user stays, on the shopping mall page.

In an exemplary embodiment, the interest price range calculation module 119 may check the price of a product for which the time when the gaze of the user stays on the shopping mall page is less than a preset first time, and determine that the price range of the product is of little interest to the user. The interest price range calculation module 119 may check the price of a product for which the time when the gaze of the user stays on the shopping mall page is equal to or longer than a second time set to be longer than the first time, and determine that the price range of the product is of great interest to the user.

The interest price range calculation module 119 may calculate the interest price range of the user based on the price of the product for which the time when the gaze of the user stays is less than the preset first time and the price of the product for which the time when the gaze of the user stays is equal to or longer than the preset second time, on the shopping mall page. Here, the product arrangement module 115 may rearrange each product into products corresponding to interest price range of the user on the shopping mall page based on the interest price range of the user.

The emotion analysis module 121 may analyze the emotion of the user for the shopping mall page based on a face photographed image for the user. In an exemplary embodiment, the emotion analysis module 121 may extract the expression of the user from the face photographed image for the user and analyze the emotion of the user on the shopping mall page based on the extracted expression. The emotion analysis module 121 may analyze the emotion of the user for each shopping mall page and monitor reaction of the user to each shopping mall page.

In the present specification, a module may mean a functional and structural combination of hardware for carrying out the technical idea of the present disclosure and software for driving the hardware. For example, the “module” may mean a logical unit of a predetermined code and a hardware resource for executing the predetermined code, and does not necessarily mean physically connected code or a single type of hardware.

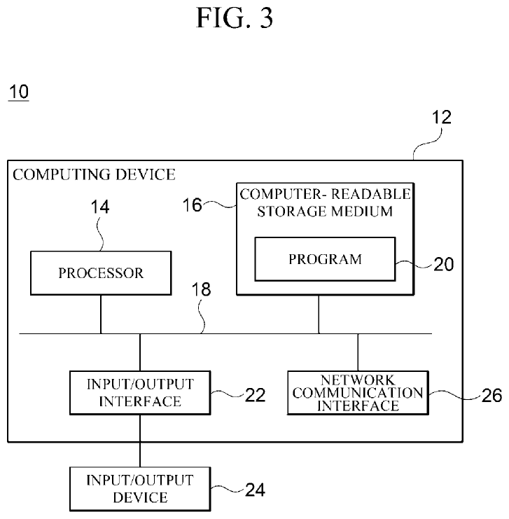

FIG. 3 is a block diagram exemplarily illustrating a computing environment 10 that includes a computing device suitable for use in embodiments of the present disclosure. In the illustrated embodiment, each component may have different functions and capabilities in addition to those described below, and additional components may be included in addition to those described below.

The illustrated computing environment 10 includes a computing device 12. In an embodiment, the computing device 12 may be the user terminal 102. Furthermore, the computing device 12 may be the shopping mall management server 104.

The computing device 12 includes at least one processor 14, a computer-readable storage medium 16, and a communication bus 18. The processor 14 may cause the computing device 12 to operate according to the above-described exemplary embodiments. For example, the processor 14 may execute one or more programs stored in the computer-readable storage medium 16. The one or more programs may include one or more computer-executable instructions, which may be configured to cause, when executed by the processor 14, the computing device 12 to perform operations according to the exemplary embodiments.

The computer-readable storage medium 16 is configured to store computer-executable instructions or program codes, program data, and/or other suitable forms of information. A program 20 stored in the computer-readable storage medium 16 includes a set of instructions executable by the processor 14. In an embodiment, the computer-readable storage medium 16 may be a memory (a volatile memory such as a random access memory, a non-volatile memory, or any suitable combination thereof), one or more magnetic disk storage devices, optical disc storage devices, flash memory devices, other types of storage media that are accessible by the computing device 12 and may store desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 via the input/output interface 22. The exemplary input/output device 24 may include a pointing device (a mouse, a trackpad, or the like), a keyboard, a touch input device (a touch pad, a touch screen, or the like), a voice or sound input device, input devices such as various types of sensor devices and/or imaging devices, and/or output devices such as a display device, a printer, an interlocutor, and/or a network card. The exemplary input/output device 24 may be included inside the computing device 12 as a component constituting the computing device 12, or may be connected to the computing device 12 as a separate device distinct from the computing device 12.

Although the representative embodiments of the present disclosure have been described in detail as above, those skilled in the art will understand that various modifications may be made thereto without departing from the scope of the present disclosure. Therefore, the scope of rights of the present disclosure should not be limited to the described embodiments, but should be defined not only by the claims set forth below but also by equivalents of the claims.

1. A computing device comprising:
one or more processors;
a memory storing one or more programs executed by the one or more processors;
a communication module configured to receive eye tracking information about a user on a shopping mall page from a user terminal;
a product arrangement module configured to rearrange a product displayed on the shopping mall page based on the eye tracking information; and
an interest price range calculation module configured to calculate an interest price range of the user based on a price of a product in which a gaze of the user stays on the shopping mall page and a time when the gaze of the user stays,
wherein the product arrangement module calculates an interest level of each of the products displayed on the shopping mall page based on the eye tracking information, and deletes, from a landing page of the shopping mall pages, a product with the interest level equal to or lower than a preset threshold during a preset period of time among products displayed on the landing page; and
the interest price range calculation module calculates the interest price range of the user based on a price of a product for which the time when the gaze of the user stays is less than a preset first time and a price of a product for which the time when the gaze of the user stays is equal to or longer than a second time set to be longer than the first time, on the shopping mall page.

2. The computing device of claim 1, wherein the product arrangement module rearranges each of the products on the shopping mall page according to the calculated interest level.

3. The computing device of claim 2, wherein the product arrangement module checks a total stay time of gazes of users and a total number of times of the gazes of the users for each of the products on the shopping mall page based on the eye tracking information, and calculates the interest level for each of the products based on the total stay time of the gazes of users and the total number of times of the gazes of the users.

4. The computing device of claim 1, wherein the product arrangement module calculates a gaze level of users for each of areas of the shopping mall page based on the eye tracking information, and rearranges each product on the shopping mall page based on the gaze level of users and a yield of each product for each of the areas of the shopping mall page.

5. The computing device of claim 4, wherein the product arrangement module arranges products having higher yields in areas where the gaze levels of users are higher on the shopping mall page.

6. The computing device of claim 1, wherein the product arrangement module predicts a next gaze position of the user on the shopping mall page based on the eye tracking information, and arranges a preset product at the predicted next gaze position.

7. The computing device of claim 1, further comprising an event management module configured to extract a product of interest of the user from among the products displayed on the shopping mall page based on the eye tracking information, and provide event information on the product of interest to the user terminal when an event is conducted for the product of interest.

8. The computing device of claim 1, further comprising an information providing module configured to provide information in another form about a product displayed on the shopping mall page based on the eye tracking information.

9. The computing device of claim 8, wherein the information providing module changes an image of a product in which the gaze of the user stays for a preset reference time or longer or a product at which the user gazes a preset reference number of times or more on the shopping mall page from 2D to 3D and displays the changed image.

10. The computing device of claim 8, wherein the information providing module extracts a product of interest of the user from among the products displayed on the shopping mall page, and provides a related product corresponding to the product of interest in a form of a thumbnail image or a pop-up window.

11. The computing device of claim 8, wherein the information providing module checks a residence time of the user on a product detail page of the shopping mall pages, and calculates a concentration level of the user on the product detail page based on the eye tracking information and the residence time on the product detail page.

12. The computing device of claim 11, wherein the information providing module provides, to the user terminal, additional purchase information about a product corresponding to the product detail page, when the concentration level of the user on the product detail page is equal to or greater than a preset reference, but the user does not purchase the product.

13. The computing device of claim 8, wherein the information providing module calculates a page residence time for each shopping mall page with respect to the user, calculates the concentration level of the user for each shopping mall page based on the page residence time and the eye tracking information, and sets a preset number of shopping mall pages having the highest concentration level of the user among the shopping mall pages as bookmarks.

14. The computing device of claim 1, wherein the communication module receives, from the user terminal, a face photographed image of the user viewing the shopping mall page, and
the computing device further comprises an emotion analysis module configured to analyze emotion of the user on the shopping mall page based on the face photographed image.

15. A system for a shopping mall service using eye tracking, the system comprising:
a user terminal configured to generate eye tracking information about a user on a shopping mall page; and
a shopping mall management server configured to receive the eye tracking information from the user terminal, and rearranges a product displayed on the shopping mall page based on the eye tracking information,
wherein the shopping mall management server is configured to calculate:
an interest level of each of the products displayed on the shopping mall page based on the eye tracking information, and deletes, from a landing page of the shopping mall pages, a product with the interest level equal to or lower than a preset threshold during a predetermined period of time among products displayed on the landing page; and
an interest price range of the user based on a price of a product for which a time when the gaze of the user stays is less than a preset first time and a price of a product for which the time when the gaze of the user stays is equal to or longer than a second time set to be longer than the first time, on the shopping mall page.
